(19) United States
(12) Patent Application Publication
(10) Pub. No.: US 2019/0240704 A1
(43) Pub. Date: Aug. 8, 2019

(54) CANNABIS BUD TRIMMING TOOL CLEANING DEVICE AND METHODOLOGY

(71) Applicant: Mary Elizabeth Ann Brooks, Halfmoon Bay (CA)

(72) Inventor: Mary Elizabeth Ann Brooks, Halfmoon Bay (CA)

(21) Appl. No.: 16/268,187

(22) Filed: Feb. 5, 2019

Related U.S. Application Data
(60) Provisional application No. 62/627,092, filed on Feb. 6, 2018.

(51) Int. Cl. B08B 1/00; A01G 3/02; A45F 5/00

(52) U.S. Cl. CPC B08B 1/006; B08B 1/007; A01G 2003/005; A45F 5/00; A01G 3/02

(57) ABSTRACT

A trimming tool cleaning system (100) includes a solvent reservoir (102) containing a solvent such as vegetable oil for the plant resin, a wristband (104), and a trimming tool (106). The tool (106) is used to trim plant material with resin, e.g., trim the sugar leaves and buds of a cannabis plant. The blades (108) of the trimming tool (106) can be wiped on the band (104) so that the blades (108) are lightly coated with the solvent. The solvent in reservoir (102) is used to wet the wristband. The solvent then protects the blades (108) from gumming up and facilitates cleaning of the blades (108).

### CROSS-REFERENCE TO RELATED APPLICATION

This application claims priority from U.S. Provisional Application No. 62/627,092, entitled, “Cannabis Bud Trimming Tool Cleaning Device And Methodology,” filed on Feb. 6, 2018. The content of the above-noted application is incorporated herein by reference as if set forth in full and priority to this application is claimed to the full extent allowable under U.S. law and regulations.

### BACKGROUND OF THE INVENTION

This invention pertains to increasing manufacturing efficiency, reducing costs, reducing workplace hazards, and greatly enhancing the quality of the finished goods in the processing of harvested cannabis plants, making it possible to more rapidly prepare them for use in the extraction of active ingredients, preparing tinctures or medicinal products, and creating traditional psychoactive smokable products, cosmetics, and consumable food and beverage products.

### BACKGROUND OF THE INVENTION

In the cannabis industry the manufacturing process is divided into farming, turning the harvested plants into the raw materials necessary for their intended uses, and making and packaging products.

Once the plants are grown to their maximum yield and harvested, the central activity in processing cannabis plants begins with dividing plants into their various parts e.g., stems, large leaves, small leaves (“sugar leaves”), and buds. After the plants have been divided, that which lacks economic value is discarded, and attention is given to building a stock of raw materials for their various uses. Because there are little or no psychoactive substances in the stalks and the large leaves, the small “sugar leaves” around the buds and the buds themselves become the central raw material.

For both recreational and medicinal purposes, the plants are grown to produce a psychoactive compound known as tetrahydocannabinoid (“THC”). The THC is produced by the resin glands found in the buds themselves, and to a lesser extent, on the “sugar leaves.” Specifically, the THC is located in the sticky oils and waxes (“resin”) found in the crystals and trichomes on the buds.

Trimming or manicuring the buds is a principal manufacturing process for the industry. It is the most time-consuming step and it requires the greatest operator skill. Scissors or specialized “snips” are used to ready the plant. The first step is to trim away the non-psychoactive parts of the plants so that only those parts which have the THC in them remain for processing. As the buds are attached to stems, a small amount of stem is left intact to make it easier to hold the buds or hang them for drying during a later stage in the processing.

Surrounding the buds are many small sugar leaves which need to be trimmed down to the stalk from which they grow. Thus the second step is to remove and set aside the sugar leaves that have resin glands on them and evident crystalline material. These leaves are trimmed with care to avoid damaging the bud itself. Once these leaves are removed they are set aside for use in making tinctures, hashish, or edible products. Removing the sugar leaves also mellows the buds for smoking, and reduces the incidence of hacking and coughing that is often characteristic of smoking cannabis.

The art of the trimming process is to remove as much as possible without damaging or destroying the bud itself. The buds on each plant are then carefully inspected, shaped, and given a final grooming. The sticky crystalline extrusion of oils and wax is visible on the bud itself, and that is where the greatest amount and most potent THC is found. While the trimmed sugar leaves contain THC, it is to a lesser extent and it is also less potent.

Trimming and manicuring the buds creates the essential raw material necessary for most or all of the many cannabis-based products that are produced in the industry. Trimming is a labor-intensive activity that has to be done by hand and that requires a skilled operator to snip the small leaves around the bud without damaging the crystalline THC and to prepare the bud for use.

The work needs to be very precisely done. Over the years the kind of pruning equipment has improved from regular household scissors to short bladed garden or nursery snips or more surgical snips that allow snipping to be accomplished in small tight locations with the least effort. All such equipment is referred to herein as trimming tools. The workers work until their tools become too gummed up with the oils and waxy residue from the buds to reasonably continue. At that time, there is no easy way to clean the trimming tools used by bud trimmers. While skilled trimmers build-up speed in their trimming activities, even the most skilled are still left with the need to use a knife or scraping device to scrape away the sticky waxy residue that has become shellacked onto the blades and the surrounding portions of the trimming device, and then to use isopropyl alcohol to clean the remaining residue by soaking their tools in a container and finally wiping them clean with a paper towel. Scraping can damage the cutting blades of the trimming tool, and presents the occasion for worker injury.

Some trimmers find it more expedient to clean the blades of their trimming tool by burning the blades clean with a cigarette lighter, and then to continue to clean them with the isopropyl step. This second technique is considered to be more dangerous, although scraping is not without risk itself. Nevertheless, the burning technique can also damage the tools themselves, in particular in the action between the handles and the two blades. Further, isopropyl alcohol is flammable and must be kept away from heat, sparks, electrical exposure, fire or flames. Thus there is an increased risk of explosion or fire should the flame or the heat of the burned tool too quickly come into contact with the alcohol. Burning, in addition to being a fire hazard with the alcohol, also warps the cutting blades and dulls them appreciably. Dull blades then tear at the bud and make it hard to get a clean, precise cut without inflicting damage to the surrounding material and loss of the crystalline THC.

Both techniques in the industry rely on the use of alcohol at the end to continue to clean the blades, as neither scraping nor burning entirely cleans the surface of the tool for optimal work, and thus both methods must contend with the fumes arising from the alcohol which can be harmful, can cause skin irritation, and other bodily reactions. The isopropyl also has a strong, noxious odor that is very disagreeable and, in practice, the liquid may easily be spilled in the workplace decreasing the efficiency of the trimming production and contaminating by-products.

These are the common practices in the industry at this time, to scrape or burn the blades and then, assuming the waxes and plant oils have been largely removed, to let them soak in isopropyl alcohol for hours, or even overnight, until a paper towel can be used to clean the remaining residue off the blades.

### SUMMARY OF THE INVENTION

The present invention proceeds from the recognition that the resins associated with plants including cannabis are oil soluble, and that if there is a thin film of vegetable oil on the blades of the tool, the cannabis resins will tend not to stick to the coated surface and will allow the blades to deliver a clean, precise cut without fouling the resulting product. The same applies with respect to oil-soluble resins of other plants.

In accordance with one aspect of the present invention, a product is provided for assisting in cutting plants that have resin such as cannabis. The product includes an article having a surface that is exposed for external access so as to enable wiping of blades of a plant trimming tool on said surface, and a nonflammable solvent for the resin disposed on the surface. The surface is formed from knitted or woven cloth suitable for washing and reuse. In one implementation, the article is adapted for wearing on the body of a worker for convenient access. In other implementations, the article is provided as a cleaning cloth that can be positioned on a novel support structure. For example, the cloth article may be provided as at least a portion of a wristband. The article is preferably formed from an absorbent material suitable for holding a quantity of the solvent substantially without dripping. In addition, the surface of the article preferably is formed using a coarse weave so as to enhance friction and improve blade cleaning. For example, the article may be formed from cotton, wool, or similar fibrous cloth. Such materials may be blended together or blended with other fibers such as polyester fibers. However, it has been found that polyester blends may have a texture that is not rough enough for optimal scrubbing properties and can reduce the ability of the fabric to hold the solvent. Rather, 100% wool has been found to perform better in this regard. The nonflammable solvent preferably has a flashpoint of at least 400° F. and more preferably at least 500° F. In this regard, the nonflammable solvent may comprise an oil such as a plant-based oil. In one implementation, the solvent is vegetable oil.

In accordance with another aspect of the present invention, a method is provided for use in trimming plants that have resin such as cannabis. The method involves providing a cloth article having a cloth surface that is exposed for external access and wetting the cloth surface with a nonflammable solvent for the resin. As described above, the cloth article may be a wearable article such as a wristband and the nonflammable solvent may be an oil such as vegetable oil. The method further involves clipping a resin bearing portion of a plant with a plant trimming tool having cutting blades, first wiping the cutting blades on the cloth surface wetted with the nonflammable solvent such that the cutting blades are coated with the nonflammable solvent, and using the cutting blades to trim a plant having resin, wherein residue from the plant is transferred to the cutting blades. It will be appreciated that, because of the coating of nonflammable solvent, the residue transferred to the cutting blades generally will not stick to the cutting blades but will merely be supported on the cutting blades. The method further involves wiping the cutting blades on the cloth surface such that at least some of the residue is transferred to the cloth surface and washing the cloth article to remove the residue from the cloth surface. In the case of industrial applications, it will be appreciated that the cloth surface may become significantly encrusted with residue over the course of a shift. Because the article is formed from cloth, it can be conveniently hand washed or machine washed for reuse.

In one implementation, the invention includes a wristband knit to form a continuous round shape reminiscent of the top of a sock. The wristband is formed from cloth that has a length between about 6-8 inches, to accommodate most users, and a width of between about 2-4 inches so as to provide a substantial surface for wiping blades without risk of missing the surface. This width also holds a substantial quantity of plant residue before cleaning is required. The resultant band is preferably made from slightly stretchy fabric to form a cuff to be worn around the wrist and on top of general purpose rubber surgical gloves. The wristband can be formed and manufactured on a circular knitting loom by hand or by machine loom akin to the kinds of looms that manufacture socks. The knitting loom allows a precise weave of the material to create a one piece, continuous object with a rough face and smooth edges that resist fraying. Alternatively, the wristband can be formed as a strip of cloth fabric with ends and can be provided with a fastening mechanism that allows for fastening, unfastening and, preferably, size adjustment. For example, the fastening mechanism may include hook and loop fasteners (e.g., Velcro®), clasps, buckles, straps and loops, or other fasteners.

The wristband fabric may be a blend of wool and synthetic fibers such as 75% merino wool and 25% polyester fibers. However, as noted above, 100% wool fabric has been found to provide better scrubbing ability and has a greater capacity to hold the oil. In this regard, after experimentation with various fabrics to assess their ability to hold an adequate volume of vegetable oil, to retain a working shape, and to withstand the drawing of the flat side of cutting blades across it, the inventor found that 100% merino wool held a maximum amount of vegetable oil without runoff andwithstood the passage of snip blades across the face of the cuff without damage. The merino wool held 30% more oil than other fabrics tested, and, importantly, wicked the vegetable oil to the surface, while also presenting a somewhat rough and abrasive surface to aid and abet the cleaning or combing of the snipper blades. Further, the chosen fabrics caused no chemical interaction or degradation with the oil nor did they erode or degrade rubber surgical gloves.

Bud trimmers wear surgical gloves to maintain sanitary handling conditions for the raw materials, and because if the sticky plant material builds up directly on the hands it can become very difficult to clean it off and may transdermally transfer unwanted THC into the worker's body leading to intoxication.

In preparation for the trimming process, about one tablespoon of vegetable oil can be initially applied to the top of the band and then, while trimming buds, the snip blades are periodically drawn with light pressure across the wristband to keep them clean of plant material and well lubricated. During the trimming production, the oil supply within the wristband or cuff may be replenished periodically, for example every 2-3 hours, as it is consumed, and with each new application the band is rotated and resaturated to present a new working face for the drawing of the blades of the tool.

Every third or fourth bud, the cutting blades are drawn across the cloth face presented on the wristband. Because the sticky oils and waxes extruded by the resin glands located on the buds are oil soluble, they don't shellac the blades but remain suspended for easy removal so long as the vegetable oil is present. At the end of a working period, the sticky oils and waxes are held on the cutting surface substantially without sticking and they are easily wiped away from the blades and the action of the snips without the need of scraping, burning, or alcohol or any clean up session. Similarly, the plant residue collected on the cloth surface is held substantially without sticking and the cloth article can be easily hand or machine washed.

Thus the wristband reduces or substantially eliminates the need to stop and clean the snip blades which can take 2-3 minutes or more during which no further production can be done. During a regular eight hour shift, the trimming tool can need to be cleaned every 30 minutes, or 16 times in an eight hour shift, with a loss of over 30-45 minutes in production time. Because the oiled wristband only occasionally requires a tablespoon of oil, which takes a negligible amount of time to administer, its use increases daily production time by 6-9% or more. Each wristband lasts for the entire 8 hour shift and can be machine washed for the next day.

Because the invention allows for surgically clean cuts and precision trimming of the cannabis buds, perhaps the greatest result from this invention is that it allows the creation of a significantly more presentable finished product with a premium appearance, while still substantially increasing productivity, reducing workplace hazards, and reducing overall operating costs as there are no scraping tools, lighters or torches, isopropyl alcohol, soaking containers, or gummed up and dulled trimming tools to be replaced.

The present invention thus relates to certain articles and a system for assisting workers in keeping the blades of trimming tools clean, particularly when trimming plants containing resins. This improves the productivity of the workers, improves the quality of the resulting products and enhances workplace safety. While trimming cannabis is a particularly advantageous application of the invention, it is anticipated that the invention will be advantageous for trimming other plant material that may tend to gum up the blades of a trimming tool.

### BRIEF DESCRIPTION OF DRAWINGS

For a more complete understanding of the present invention and further advantages thereof, reference is now made to the following Detailed Description, taken in conjunction with the drawings in which:

FIG. 1 is a drawing of a trimming tool cleaning device in accordance with the present invention;

FIG. 2 shows a wristband positioned over a glove on the wrist of a worker in accordance with the present invention;

FIG. 3 shows a trimming tool being wiped on a cleaning cloth in accordance with the present invention;

FIGS. 4A-4D are cross-sectional views of various embodiments of a cleaning cloth in accordance with the present invention;

FIG. 5 is a flowchart illustrating a trimming tool cleaning process in accordance with the present invention;

FIG. 6 shows a wearable article in accordance with an alternative embodiment of the present invention; and

FIG. 7 shows a support structure for a cloth article in accordance with the present invention.

### DETAILED DESCRIPTION

In the following description, the invention is set forth in the context of a specific system that is particularly advantageous for cannabis trimming. In this regard, a specific wearable cloth is described, as well as particular solvents. Other implementations of the invention are possible. For example, the cloth need not be wearable (e.g., the cloth may be mounted on a support accessible in the trimming workplace) and other solvents are possible, as well as other techniques for wetting the cutting blades. It will thus be appreciated that the system is set forth to illustrate the invention and not by way of limitation.

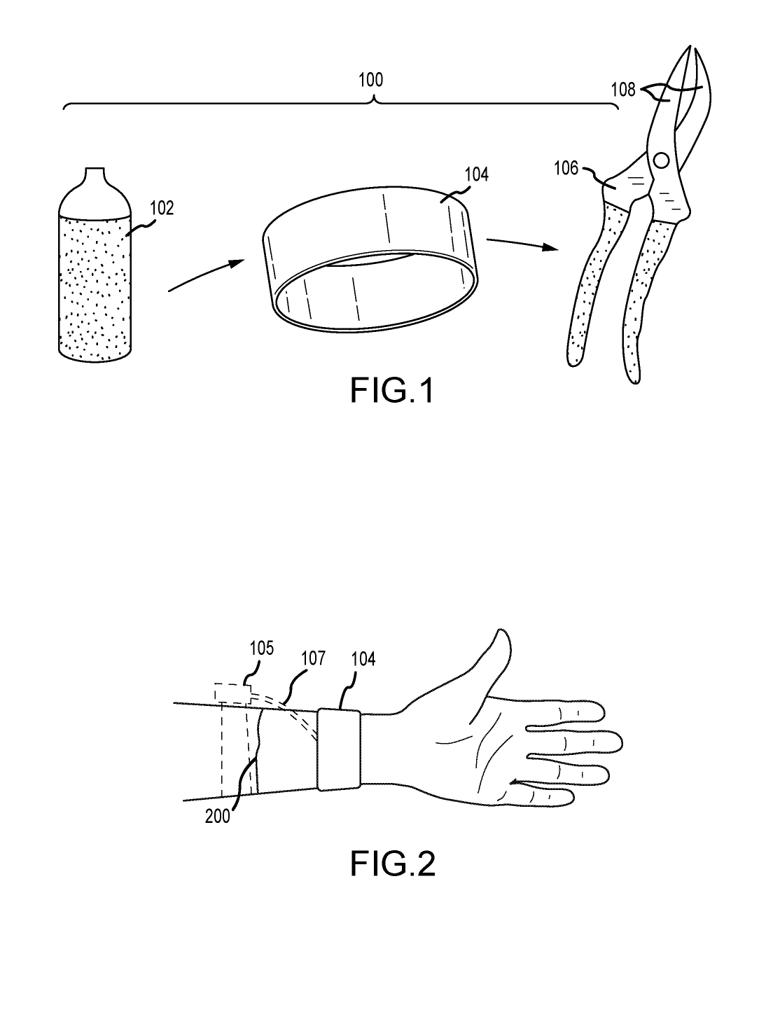

FIG. 1 illustrates a trimming tool cleaning system 100 in accordance with the present invention. The system 100 includes a solvent reservoir 102 containing a solvent for the plant resin, a wristband 104, and a trimming tool 106. Briefly, the tool 106 is used to trim plant material with resin, e.g., trim the sugar leaves and buds of a cannabis plant as described above. The blades 108 of the trimming tool 106 can be wiped on the band 104 so that the blades are lightly coated with the solvent. The solvent in reservoir 102 is used to wet the wristband. The solvent then protects the blades 108 from gumming up and facilitates cleaning of the blades 108.

The reservoir 102 contains a suitable solvent for dissolving the plant resin and/or inhibiting the resin from sticking to and gumming up the blades 108. Preferred qualities of the solvent include the following. First, the solvent should dissolve the plant resin and/or inhibit sticking of the resin to the blades 108. In addition, the solvent is preferably non-toxic to workers and does not unduly irritate the skin of the workers. As discussed below, the workers will typically wear gloves when trimming cannabis plants. While this minimizes the concern of skin irritation, it is still expected that workers will have some contact with the solvent.

The solvent is also preferably nonflammable. That is, the solvent preferably has a flashpoint in excess of 400° F. and, more preferably, in excess of 500° F. As noted above, workers often use an open flame to help clean cutting surfaces. This practice may continue, to a limited extent, even when utilizing the trimming tool cleaning system 100 of the present invention. Accordingly, workplace hazards can be reduced by providing a solvent that is nonflammable.

In consideration of the foregoing preferred characteristics, suitable solvents include various oils. Certain plant resins, including cannabis resins, are oil soluble. Certain oils are also non-toxic to workers, generally do not irritate skin, and are nonflammable. Preferred oils in this regard include plant-based oils. In the illustrated system 100 the reservoir 102 holds a vegetable oil, for example, a cooking oil such as cannola oil.

The wristband 104 holds a supply of the solvent, transfers the solvent to the blades 108, and is also effective to clean the cutting blades 108 by wiping. While it is not essential to be wearable, it is convenient for the cloth surface to be readily accessible to workers during trimming. It has been found to be particularly advantageous to provide the cloth surface in the form of a wristband that can be worn on the non-cutting hand of the worker. In this regard, the wristband 104 preferably has a width sufficient for wiping the cutting blades and holding a substantial quantity of plant residue before requiring cleanings and a length sufficient to extend around the wrist of typical workers. In addition, the wristband 104 preferably has a thickness, considered in relation to the cloth material and weave, sufficient to resist penetration by the cutting blades 108 during normal use. The wristband 104 may be somewhat elastic so as to stretch over the hand of the worker when being placed on the worker's wrist or removed therefrom while also staying securely in position on the worker's wrist during use so as to facilitate wiping. As an alternative to being somewhat elastic, the wristband may be adjustable, e.g., using clasps or Velcro as will be described below. In the illustrated embodiment, the wristband 104 is between about 2 to 4 inches wide, for example, 2.5 inches. The illustrated wristband 104 has an unstretched length of about 6 to 8 inches. The thickness of the wristband 104 may be between about ⅛-½ inch, for example, about ¼ inch.

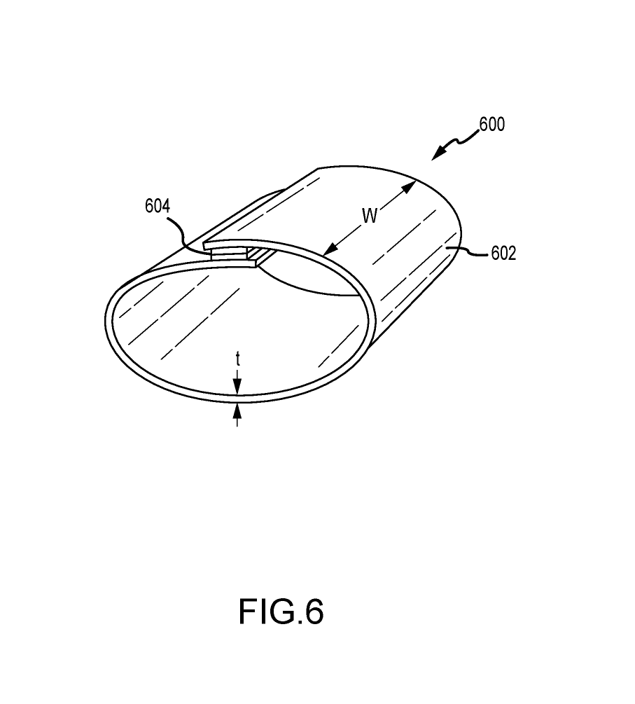

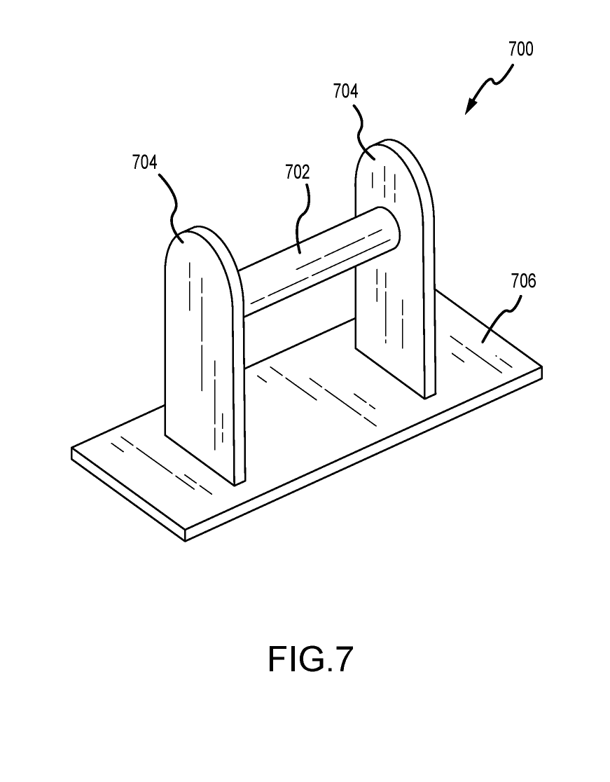

FIG. 6 shows a perspective view of an alternative wristband 600 in accordance with the present invention. In this case, the wristband 600 is formed from a strip of fabric 602. The fabric 602 can be folded about the wrist of a user and fastened in place by fastener 604. Preferably, the fastener 604 can be easily attached and detached (e.g., for washing) and allows for size adjustment so that the wristband 600 can be snuggly applied to the wrist of a user. The fastener 604 may comprise a hook and loop fastener, snaps, clasps, buckles, straps and loops, or any other suitable fastening device. In the illustrated embodiment, the fastener 604 comprises Velcro® strips having a width sufficient to enable a suitable range of size adjustment. The wristband 600 may be otherwise constructed from fabric as described above. The illustrated waistband has a width, w, a thickness, t, and a length corresponding to the maximum dimension of the strip of fabric 602 when unfolded. These dimensions may be generally as described above except that the length may be increased slightly to allow for overlap at the fastener 604.

Referring again to FIG. 1, at least a portion of the exposed external surface of the wristband 104 is adapted to facilitate the wiping function. In this regard, the exposed surface portion is suitable for carrying a quantity of solvent. In addition, the exposed surface portion is preferably rough enough to serve as an effective wipe, but preferably is still comfortable for the worker (who will generally wear gloves underneath the wristband in the case of cannabis trimming). A variety of fabrics with a variety of weaves are suitable in this regard. However, smooth materials such as certain synthetic fibers and smooth natural fibers, may not have a sufficient coefficient of friction to serve as an effective cleaning surface, particularly when wetted with a solvent. Such fibers also may not hold a sufficient quantity of oil without runoff to be an efficient option.

The wristband 104 is formed from woven or knitted cloth suitable for washing and re-use, e.g., cotton, wool or other cloth, blends of such materials, or blends with other fibers such as nylons or polyesters, and is preferably not formed from nonwashable or easily degraded materials such as paper. The illustrated wristband 104 is formed from natural fibers and is fabricated using a weave that renders the external surface somewhat rough. For example, the wristband 104 may be formed from a fabric that is 100% merino wool. It has been found that this fabric held a maximum amount of vegetable oil without runoff and withstood the passage of cutting blades across the face of the wristband without damage. More specifically, the merino wool held 30% more oil than other fabrics tested and wicked the vegetable oil to the surface while also presenting a somewhat rough and abrasive surface to aid the cleaning of the cutting blades of the trimming tool. In addition, this fabric had no noted chemical interaction or degradation associated with exposure to the preferred solvent (vegetable oil) and did not degrade the rubber surgical gloves typically used by workers in handling cannabis.

The trimming tool 106 may be any trimming tool suitable for the plant material being trimmed. Specific trimming tools have been developed for cannabis. Moreover, multiple trimming tools may be used for coarse and precision cuts, and all trimming tools can be kept clean using the band 104 and solvent from the reservoir 102.

As noted above, in connection with cannabis trimming, it is common to wear gloves to maintain sanitary conditions, avoid buildup of resin on the hands of workers and avoid transdermal transfer of THC into the worker's body. As shown in FIG. 2, the wristband 104 can be worn over the gloves. The gloves 200 can be surgical gloves of the type commonly worn by cannabis workers. If desired, sturdy gloves may be worn to protect the hands and wrist of the worker from the cutting blades. Depending on the solvent utilized, the material of the gloves can be selected to avoid degradation or other undesired effects.

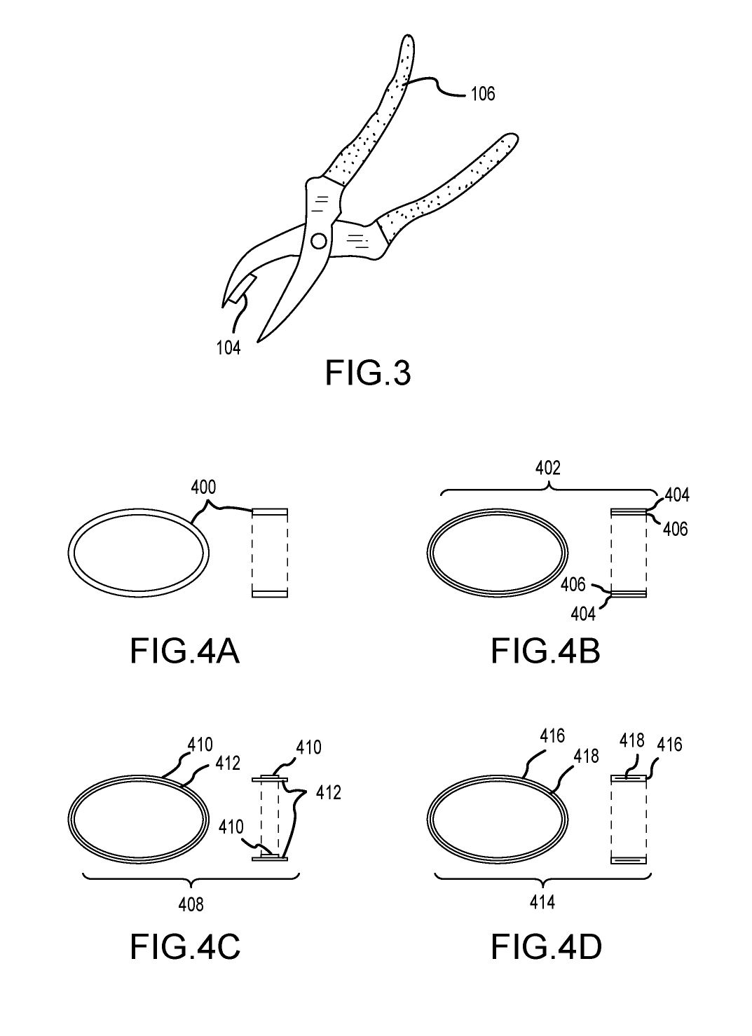

As noted above, the blades are periodically wiped on the wristband during use, for example, after trimming 3 to 4 buds or on a regular timed basis, e.g., every 5 to 10 minutes. This is shown in FIG. 3. By lightly passing the cutting edges of the blades 108 over the wristband 104, a thin film of solvent is applied uniformly over the blades 108 so as to resist buildup of resins. The blades 108 may be wiped one at a time or both blades may be wiped at once. In addition, the tool 106 may be flipped over to wipe of the other sides of the blades 108. The illustrated band 104 is effective to provide the thin film as desired. However, a separate cloth or wipe can be used to spread the solvent to achieve a uniform coating if desired.

FIGS. 4A-4D show side and top cross-sectional views of a cleaning cloth in accordance with the present invention that may be configured as a wristband as described above or a cuff for placement on a support as described below. It will be appreciated that the cleaning cloth need not be folded in a loop as shown, when not used as a wristband, but may be a flat piece of fabric or formed on a convex surface for east access by the blades. FIG. 4A illustrates an embodiment of the cloth 400 having a unitary construction. For example, the cloth 400 may be formed from a fabric as described above comprising merino wool. FIG. 4B illustrates an alternative construction that includes a cloth layer 404 with a backing material 406. For example, the backing surface 406 may be another fabric or another material such as plastic, rubber, or Kevlar. The backing 406 may be used to provide a nonslip surface, to provide protection against skin cutting due to the blades, or to isolate the worker's skin from the solvent among other things. The backing 406 may be attached to the fabric surface 404 by stitching, adhesive, or other means.

FIG. 4C shows a further embodiment of the cleaning cloth 408 including a fabric layer 410 over a liner 412. Again, the fabric layer 410 may be formed from a fabric as described above. The liner 412 may be a separately provided glove or other liner worn between the fabric 410 and the worker's skin. The liner 412 may be formed from another fabric, plastic, rubber, Kevlar, or other suitable material. The liner may be used to protect the worker's skin from the solvent or cutting blades.

FIG. 4D shows a still further embodiment of a cleaning cloth 414 in accordance with the present invention. The illustrated cloth 414 includes a fabric 416 with an embedded protective layer 418. The fabric 416 may be a fabric as described above. The protective layer 418 may be formed from another fabric, plastic, rubber, Kevlar or other material. The layer 418 may protect against the cutting blades and may also provide a desired shape or resiliency to the cleaning cloth 414.

FIG. 7 is a perspective view of a cleaning cloth support 700 in accordance with the present invention. As noted above, a cleaning cloth may be placed on a support in the vicinity of a work environment rather than being worn on the body of a worker. This may be desired, for example, to avoid any risk associated with wiping blades on the worker's wrist or to provide a larger cleaning cloth surface area. Such an enlarged cleaning cloth may be used by multiple workers. FIG. 7 illustrates a cleaning cloth support 700 that includes a cloth support bar 702 supported on a base 706 by side members 704. The bar 702, members 704, and base 706 may be formed from any suitable materials such as wood, metal, plastic or the like.

The support bar 702 may have any desired cross-sectional shape such as square, rectangular, round, oval or the like. Preferably, the external surface of the bar 702 is convex or curved to facilitate blade wiping. In the illustrated embodiment, the bar 702 has a round or oval cross-section. The bar 702 is preferably mounted on the side members 704 so as to resist turning or spinning about its major axis when blades are wiped against the bar 702. Preferably, the bar 702 can be removed from the side members 704 to install or remove a cleaning cloth from the bar 702. In this regard, the bar may be formed from two telescoping pieces that are spring-loaded so as to allow the bar to be secured within openings of the side members 704 and removed therefrom as desired. Alternatively, spring-loaded protrusions may be provided on the ends of the bar 702 to engage openings of the side members 704.

In operation, the bar 702 may be removed from the side members 704 such that a closed loop cleaning cloth can be slid over the end of the bar 702 to a desired position and the bar 702 can then be installed into the side members 704. Alternatively, a strip of cleaning cloth with appropriate fasteners can be placed over the bar 702 while the bar is installed between the side members 704 and the fasteners can then be used to secure the cloth in position. In either case, a reservoir of solvent such as vegetable oil may be provided in proximity to the support 700. The solvent can then be used as necessary to wet the cloth in position on the bar 702. Alternatively, the bar 702 with a cleaning cloth installed thereon can be rolled across a solvent reservoir or a blotter or oil tray. The bar 702 can be configured to be selectively locked or unlocked concerning rotation in relation to the side members 704 so that the support can be used to roll the cloth on an oil tray with the bar unlocked, and the bar 702 can be locked for use in wiping the cutting blades.

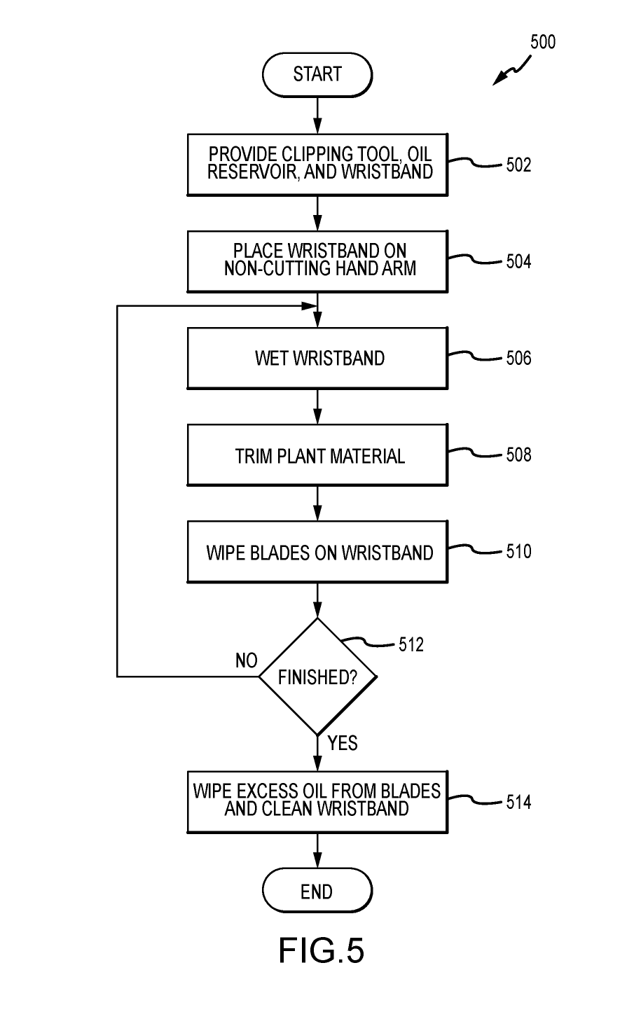

FIG. 5 is a flowchart summarizing a process 500 in accordance with the present invention. The illustrated process 500 involves providing (502) a clipping tool, a solvent reservoir and a wristband (or other cleaning cloth) as described above. At the beginning of a trimming process, the worker may place (504) the wristband on the non-cutting arm of the worker. In the case of cannabis trimming, the worker may first insert his hand into a glove and then position the wristband over the glove.

The worker can then wet (506) the wristband. This can be done in a variety of ways. For example, the worker can pour a quantity (e.g., about 1 tablespoon) of the solvent onto the wristband using a squirt bottle, spoon or other container. Alternatively, the user can dip the wristband or a portion thereof into the solvent reservoir. It may be desirable, in this case, to wring out the wristband or otherwise remove excess solvent therefrom. It is also possible to connect a wearable reservoir 105 to the wristband as shown in phantom in FIG. 2, for example, via one or more tubes 107 or wicks, so that the wristband draws or wicks solvent from the reservoir as needed.

Once the wristband is wetted, the worker can trim (508) plant material as usual. Periodically, the worker can wipe (510) the blades of the trimming tool on the wristband so as to coat the blades with a thin film of the solvent. The worker can repeat this process of wetting the wristband, trimming plant material and wiping the blades on the wristband as required during a trimming process. It will be appreciated that residue from the plant is thus transferred to the blades and, in turn, to the fabric of the wristband (in each case substantially without sticking). If the wristband accumulates residue, the worker can turn the wristband inside-out to get a fresh wiping surface. It has been found that this flipping of the wristband can be repeated and that the surfaces are effectively self-cleaning. Consequently, the wristband can be used by a worker for a full shift without replacement or cleaning. When the trimming process is finished 512, for example, at the end of a shift or as otherwise needed, the blades can be easily wiped (514) clean with the wristband or a separate cloth or paper towel to remove excess oil and loose plant debris, and the wristband can be cleaned by hand or in a washing machine. It will be appreciated that little effort will be required to clean the trimming tool as the blades are protected from gumming up by the solvent. Nonetheless, the blades may be cleaned with other cleaning products or exposure to flames and sterilization as desired.

The foregoing description of the present invention has been presented for the purpose of illustration and description. Furthermore, the description is not intended to limit the invention to the form disclosed herein. Consequently, variations and modifications commensurate with the above teachings, and skill and knowledge of the relevant art are within the scope of the present invention. The embodiments described herein above are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

What is claimed:

1. A method for use in trimming plants that have resin, comprising:
providing a cloth article having a cloth surface that is exposed for external access;
wetting said cloth surface with a nonflammable solvent for said resin;
clipping a resin bearing portion of a plant with a plant trimming tool having cutting blades;
first wiping said cutting blades on said cloth surface wetted with said nonflammable solvent such that said cutting blades are coated with said nonflammable solvent;
using said cutting blades to trim a plant having resin, wherein residue from said plant is transferred to said cutting blades;
second wiping said cutting blades on said cloth surface such that a least some of said residue is transferred to said cloth surface; and
washing said cloth article to remove said residue from said cloth surface.

2. A method as set forth in claim 1, wherein said cloth article is adapted for wearing on the body of a worker.

3. A method as set forth in claim 2, wherein said cloth article is provided as at least a portion of a wristband.

4. A method as set forth in claim 3, wherein said cloth article is formed from a stretchable fabric.

5. A method as set forth in claim 3, wherein said cloth article includes a fastening mechanism that allows for size adjustment.

6. A method as set forth in claim 1, wherein said cloth article is formed from a cloth material suitable for holding a quantity of said solvent substantially without dripping.

7. A method as set forth in claim 1, wherein said cloth article is formed from wool.

8. A method as set forth in claim 1, wherein said nonflammable solvent has a flash point of at least 400° F.

9. A method as set forth in claim 1, wherein said nonflammable solvent has a flash point of at least 500° F.

10. A method as set forth in claim 1, wherein said nonflammable solvent comprises an oil.

11. A method as set forth in claim 10, wherein said oil is a plant-based oil.

12. A method as set forth in claim 11, wherein said oil comprises vegetable oil.

13. A product for assisting in cutting plants that have resin, comprising:
an article having a surface that is exposed for external access so as to enable wiping of blades of a plant trimming tool on said cloth surface wherein said surface is formed from knitted or woven cloth suitable for washing and re-use; and
a nonflammable solvent for said resin disposed on said cloth surface.

14. A product as set forth in claim 13, wherein said article is adapted for wearing on the body of a worker.

15. A product as set forth in claim 14, wherein said wearable cloth article is provided as at least a portion of a wristband.

16. A product as set forth in claim 14, wherein said wearable cloth article is formed from a stretchable fabric.

17. A product as set forth in claim 14, wherein said wearable cloth article includes a fastening mechanism that allows for size adjustment.

18. A product as set forth in claim 13, wherein said cloth article is formed from a cloth material suitable for holding a quantity of said solvent substantially without dripping.

19. A product as set forth in claim 13, wherein said cloth article is formed from wool.

20. A product as set forth in claim 13, wherein said nonflammable solvent has a flash point of at least 400° F.

21. A product as set forth in claim 13, wherein said nonflammable solvent has a flash point of at least 500° F.

22. A product as set forth in claim 13, wherein said nonflammable solvent comprises an oil.

23. A product as set forth in claim 22, wherein said oil is a plant-based oil.

24. A product as set forth in claim 22, wherein said oil comprises vegetable oil.
